(19) United States
(12) Patent Application Publication
(10) Pub. No.: US 2024/0261752 A1
(43) Pub. Date: Aug. 8, 2024

(54) HYDROGEN GAS PRODUCTION DEVICE USING PHOTOCATALYST

(71) Applicant: TOYOTA JIDOSHA KABUSHIKA KAISHA, Toyota-shi (JP)

(72) Inventor: Ryota TOMIZAWA, Mishima-shi (JP)

(73) Assignee: TOYOTA JIDOSHA KABUSHIKA KAISHA, Toyota-shi (JP)

(21) Appl. No.: 18/543,013

(22) Filed: Dec. 18, 2023

(30) Foreign Application Priority Data
Feb. 8, 2023 (JP) 2023-017973

(51) Int. Cl. B01J 19/12; B01J 35/39; C01B 3/04; C01B 13/02

(52) U.S. Cl. CPC B01J 19/127; B01J 35/39; C01B 3/042; C01B 13/0207; B01J 2219/0877; B01J 2219/1203; C01B 2203/80

(57) ABSTRACT

The hydrogen gas production device includes a water tank in which a hydrogen-side photocatalyst is immersed in water in which a mediator is dispersed and hydrogen gas is generated by irradiation with light, and a mediator is oxidized; a light irradiation means for irradiating the hydrogen side photocatalyst with light; a water tank in which an oxygen-side photocatalyst is immersed in the water in which the mediator is dispersed and oxygen gas is generated by irradiation with light, and a light irradiation means for irradiating the oxygen side photocatalyst with light; and a water circulation unit for circulating water in which a mediator is dispersed between the hydrogen side and the oxygen side water tank, and a light source of the light irradiation means is a light emitting diode.

### CROSS-REFERENCE TO RELATED APPLICATION

This application claims priority to Japanese Patent Application No. 2023-017973 filed on Feb. 8, 2023, incorporated herein by reference in its entirety.

### BACKGROUND

### 1. Technical Field

The present disclosure relates to a hydrogen gas production device, and more specifically, to a device for producing hydrogen gas by a decomposition reaction of water using a photocatalyst.

### 2. Description of Related Art

Since hydrogen gas that is expected to be used as a clean next-generation fuel that does not generate carbon dioxide even when burned can be generated by a decomposition reaction of water by light energy using a photocatalyst, various techniques for producing the hydrogen gas using a photocatalyst have been proposed. For example, Japanese Unexamined Patent Application Publication No. 2015-218103 (JP 2015-218103 A) proposes a configuration of a hydrogen generation device in which photocatalyst particles-dispersed water is circulated in a housing having a light receiving window to elicit a decomposition reaction of water by light, and hydrogen gas is generated together with oxygen gas. Japanese Unexamined Patent Application Publication No. 2022-63186 (JP 2022-63186 A) by the applicant of the present application proposes to improve production efficiency of hydrogen gas by warming water in a container that is to be decomposed in the photocatalyst member by exhaust heat of a light source to increase a water temperature, in a device in which a photocatalyst member for supporting a photocatalyst that generates hydrogen gas by, when irradiated with light, generating excited electrons and holes, and causing a decomposition reaction of water decomposing water into hydrogen and oxygen, is disposed so as to be immersed in the water in a container portion, and the photocatalyst member is irradiated with light from the light source driven by electric power.

In addition, with respect to the photocatalyst that elicits the decomposition reaction of water by being irradiated with light as described above, various configurations of a photocatalyst system (Z-scheme) have been proposed in which a photocatalyst (hydrogen-side photocatalyst) that exclusively reduces hydrogen ions (protons) to generate hydrogen gas, a photocatalyst (oxygen-side photocatalyst) that exclusively oxidizes water molecules to generate oxygen gas and protons, and a redox material (mediator material) that transfers electrons from the oxygen-side photocatalyst to the hydrogen-side photocatalyst are used (WO 2022/045283, “Prospects and challenges in designing photocatalytic particle suspension reactors for solar fuel processing”, Swarnava Nandy, Sangram Ashok Savant, and Sophia Haussener, Chem. Sci., 2021, 12, 9866-9884). In “Designing a Z-scheme system based on photocatalyst panels towards separated hydrogen and oxygen production from overall water splitting”, Chaoyi Dong, Yue Zhao, Yanpei Luo, Hong Wang, Hefeng Zhang, Xu Zong, Zhaochi Feng, and Can Li, Catal. Sci. Technol., 2022, 12, 572-578, a device with the following configuration is disclosed, that is, a substrate to which a hydrogen-side photocatalyst is adhered (hydrogen-side photocatalyst plate) and a substrate to which an oxygen-side photocatalyst is adhered (oxygen-side photocatalyst plate) are disposed in separate water tanks filled with an aqueous solution in which a mediator material is dispersed, the two water tanks are apposed so that sunlight is transmitted through the oxygen-side photocatalyst plate and the hydrogen-side photocatalyst plate in order and the aqueous solution in the two water tanks are circulated, and thereby, in the water tank of the oxygen-side photocatalyst plate, oxygen gas is generated, and in the water tank of the hydrogen-side photocatalyst plate, hydrogen gas is generated.

### SUMMARY

In the case of catalyzing reduction of protons and oxidation of water molecules by one photocatalyst (one-step photocatalyst system), it is necessary that a band gap between a valence band and a conduction band of the photocatalyst is large so as to straddle reduction potential of the protons (redox potential in a redox reaction system between protons and hydrogen molecules) and oxidation potential of water molecules (redox potential in a redox reaction system between water and oxygen molecules). On the other hand, in the case of the photocatalyst system of the Z-scheme as described above, a hydrogen-side photocatalyst has only to have a band gap between the valence band and the conduction band straddling the reduction potential of the protons and the redox potential of the mediator material, and the oxygen-side photocatalyst has only to have a band gap between the valence band and the conduction band straddling the redox potential of the mediator material and the oxidation potential of the water molecules. Therefore, the photocatalyst system of the Z-scheme is advantageous in that more types of materials are available as the photocatalyst (however, when there is a co-catalyst that selectively promotes a reduction reaction of the protons in the hydrogen-side photocatalyst, and there is a co-catalyst that selectively promotes an oxidation reaction of water in the oxygen-side photocatalyst, the band gap between the valence band and the conduction band of each photocatalyst may straddle the reduction potential of the protons and the oxidation potential of the water molecules). Further, in the case of a configuration in which the hydrogen-side photocatalyst and the oxygen-side photocatalyst are disposed in separate water tanks, when substantially only hydrogen gas or substantially only oxygen gas is generated in each water tank, since the generated hydrogen gas and oxygen gas are recovered separately, it is also advantageous in that a separator for separating the hydrogen gas from the oxygen gas is unnecessary (the separator may be used in order to increase the purity of the hydrogen gas in the product gas).

Meanwhile, although sunlight can be used as irradiation light to a photocatalyst that elicits a decomposition reaction of water, sunlight has low light density and an amount of hydrogen gas produced per hour is relatively small. In addition, in the case of sunlight, the ratio of contribution to the decomposition reaction of water in the light energy irradiating the photocatalyst is not very high. More specifically, first, a component in which photon energy in the irradiation light does not reach an energy width of the band gap of the photocatalyst is not absorbed by the photocatalyst and does not contribute to the decomposition reaction of water. Further, in a component in which the photon energy in the irradiation light reaches the band gap of the photocatalyst, a portion absorbed by the photocatalyst and excites the electrons of the valence band to the conduction band, and the portion exceeding the energy width of the band gap of the photocatalyst in the photon energy become heat (thermal relaxation), and thus do not contribute to the decomposition reaction of water. That is, in sunlight with a wide wavelength band, the energy absorbed by the photocatalyst and contributing to the decomposition reaction of water is only a part thereof. Further, when sunlight is used as the irradiation light to the photocatalyst, a disposing location of the water tank in which the photocatalyst is placed is limited to a location where an optical path for guiding sunlight to the photocatalyst can be set, and the amount of hydrogen gas generated is greatly affected by the weather conditions.

On the other hand, in the case where the irradiation light to the photocatalyst is provided by a light emitting device driven by electric power, the amount of hydrogen gas generated per hour can be made larger than in the case of sunlight, and it is less likely to be affected by weather conditions. It is expected that limitation of the disposing location of the water tank in which the photocatalyst is immersed can be reduced. Further, as described above, as to the requirement of photon energy required in the irradiation light, reaching the energy width of the band gap of the photocatalyst is enough, and more energy is not excessively required. Therefore, when the irradiation light from the light emitting device is adjusted so as to have a wavelength that is equal to or less than the wavelength corresponding to the energy width of the band gap of the photocatalyst, and have a wavelength as long as possible, it is possible to cause the energy of the irradiation light to contribute to the decomposition reaction of water more efficiently. In this regard, in the configuration using the photocatalyst system of the Z-scheme, since the band gap of the photocatalyst is not needed to be large enough to straddle the reduction potential of the protons and the oxidation potential of the water molecules, by adopting a suitable material as the hydrogen-side photocatalyst and the oxygen-side photocatalyst, respectively, the photon energy in the irradiation light to the photocatalyst can be lower, as compared with the case of the one-step photocatalyst system. Thus, it is advantageous in that the range of selection of the light source of the light emitting device that emits the irradiation light is widened. As a specific light source, a light emitting diode (LED) (including a semiconductor laser using an LED) that has high emission energy efficiency, that is easy to handle in installation or the like, and that has a high monochromaticity in the emitted light can be adopted. In particular, in LED, as will be described later, generally, the longer the wavelength of light, the higher the luminous efficiency per power consumption. Therefore, the smaller the band gap of the selected photocatalyst is, the irradiation light of higher luminous efficiency and longer wavelength can be selected, and accordingly, the amount of hydrogen gas generated per power consumption can be increased.

Thus, one issue of the present disclosure is to provide a configuration with which, in a device for producing hydrogen gas by a decomposition reaction of water using a photocatalyst system of a Z-scheme, the device being configured in such a manner that a hydrogen-side photocatalyst and an oxygen-side photocatalyst are disposed in separate water tanks, and hydrogen gas and oxygen gas are generated in separate water tanks, limitation of a disposing location of the water tank becomes as little as possible by adopting an LED as a light source of a light emitting device, and an amount of hydrogen gas generated per hour becomes as much as possible with energy efficiency as high as possible.

According to one aspect of the present disclosure, the issue described above is solved by,
a hydrogen gas production device including
a hydrogen gas generation unit;
an oxygen gas generation unit; and
a water circulation unit.
The hydrogen gas generation unit
includes a hydrogen-side water tank in which a hydrogen-side photocatalyst member supporting a hydrogen-side photocatalyst is immersed in water in which a mediator material is dispersed,
includes a hydrogen-side light irradiation unit that irradiates the hydrogen-side photocatalyst member with light of a wavelength that is absorbed by the hydrogen-side photocatalyst to excite electrons of a valence band of the hydrogen-side photocatalyst to a conduction band, and
includes a hydrogen gas recovery unit that recovers hydrogen gas generated in the hydrogen-side water tank. The hydrogen gas generation unit is configured such that, when the hydrogen-side photocatalyst is irradiated with the light from the hydrogen-side light irradiation unit, protons in the water are reduced in the hydrogen-side water tank to generate the hydrogen gas, and the mediator material that is reduced is oxidized. The oxygen gas generation unit
includes an oxygen-side water tank in which an oxygen-side photocatalyst member supporting an oxygen-side photocatalyst is immersed in water in which the mediator material is dispersed, and
includes an oxygen-side light irradiation unit that irradiates the oxygen-side photocatalyst member with light of a wavelength that is absorbed by the oxygen-side photocatalyst and to excite electrons of a valence band of the oxygen-side photocatalyst to a conduction band. The oxygen gas generation unit is configured such that, when the oxygen-side photocatalyst is irradiated with the light from the oxygen-side light irradiation unit, water molecules in the water are oxidized in the oxygen-side water tank to generate oxygen gas, and the mediator material that is oxidized is reduced. The water circulation unit is configured to circulate the water in which the mediator material is dispersed, between the hydrogen-side water tank and the oxygen-side water tank. In the hydrogen gas production device, a light source of a light emitting device of the hydrogen-side light irradiation unit and a light source of a light emitting device of the oxygen-side light irradiation unit are a light emitting diode.

In the above configuration, the “hydrogen-side photocatalyst”, the “oxygen-side photocatalyst”, and the “mediator material” are the hydrogen-side photocatalyst, the oxygen-side photocatalyst, and the mediator material used in the photocatalyst system of the so-called “Z-scheme”, respectively, as described above. As requirements, materials satisfying the following are selected, respectively: for the mediator material, the redox potential thereof is between the reduction potential of the protons and the oxidation potential of the water; for the hydrogen-side photocatalyst, the band gap straddles the reduction potential of the protons and the redox potential of the mediator material; and for the oxygen-side photocatalyst, the redox potential of the mediator material and the oxidation potential of the water are straddled.

The “hydrogen-side photocatalyst member” and the “oxygen-side photocatalyst member” may be members obtained by the hydrogen-side photocatalyst and the oxygen-side photocatalyst each being adhered to a surface of a member with a shape as desired such as a plate-like member made of glass, resin, etc., or may be members obtained by the hydrogen-side photocatalyst or the oxygen-side photocatalyst being solidified in a shape as desired such as a plate, respectively.

The “hydrogen-side water tank” and the “oxygen-side water tank” may be water tanks configured to store the water in which the mediator material is dispersed, and to hold the hydrogen-side photocatalyst member and the oxygen-side photocatalyst member in a desired manner in a state of being immersed in water, respectively.

The “hydrogen-side light irradiation unit” and the “oxygen-side light irradiation unit” may be devices including the optical systems and the light source devices that generate light that excites electrons of the valence bands in the oxygen-side photocatalyst and the hydrogen-side photocatalyst to the conduction bands and irradiate the hydrogen-side photocatalyst member and the oxygen-side photocatalyst member with the light, respectively. In particular, in the present disclosure, a light emitting diode having high monochromaticity and that is driven by electric power is adopted as a light source that generates the irradiation light. Note that the light emitting diode may include a semiconductor laser that emits light by laser oscillation in addition to a diode element that emits light by spontaneous emission.

The “water circulation unit” is a unit that circulates water so as to exchange water stored in the hydrogen-side water tank and the oxygen-side water tank in a desired manner. Specifically, the “water circulation unit” may be a device configured to allow water to flow between the two water tanks by using a pump or the like through a water transfer pipe connected between the hydrogen-side water tank and the oxygen-side water tank, but is not limited thereto.

In an operation of the device described above, first, in the “hydrogen gas generation unit” including the “hydrogen-side photocatalyst member”, the “hydrogen-side water tank”, the “hydrogen-side light irradiation unit”, and the “hydrogen gas recovery unit”, a reaction in which the hydrogen-side photocatalyst is irradiated with light from the hydrogen-side light irradiation unit and the protons in the water are reduced by the electrons excited in the hydrogen-side photocatalyst to generate the hydrogen gas, and a reaction in which the mediator material that is reduced is oxidized by a hole generated in the hydrogen-side photocatalyst, are elicited. On the other hand, in the “oxygen gas generation unit” including the “oxygen-side photocatalyst member”, the “oxygen-side water tank”, and the “oxygen-side light irradiation unit” (a unit for recovering the oxygen gas may or may not be provided), a reaction in which the oxygen-side photocatalyst member is irradiated with light from the oxygen-side light irradiation unit and the water molecules in the water are oxidized by the holes generated in the oxygen-side photocatalyst to generate the oxygen gas (and protons), and a reaction in which the mediator material that is oxidized is reduced by the electrons excited in the oxygen-side photocatalyst, are elicited. Further, by circulation of water between the hydrogen-side water tank and the oxygen-side water tank by the water circulation unit, the oxidant of the mediator material is transferred from the hydrogen-side water tank to the oxygen-side water tank, so that the protons and the reductant of the mediator material are transferred from the oxygen-side water tank to the hydrogen-side water tank. Therefore, the hydrogen-side photocatalyst, the oxygen-side photocatalyst, the mediator material, the irradiation light from the hydrogen-side light irradiation unit and the irradiation light from the oxygen-side light irradiation unit are each selected so that the series of reactions described above are executable. In the hydrogen-side photocatalyst, if necessary, a co-catalyst for promoting the reduction reaction of the protons (over the oxidation reaction of the water molecules and the reduction reaction of the oxidant of the mediator material) may be used, and this case also belongs to the scope of the present disclosure. Also in the oxygen-side photocatalyst, if necessary, a co-catalyst for promoting the oxidation reaction of water (over the reduction reaction of the protons and the oxidation reaction of the reductant of the mediator material) may be used, and this case also belongs to the scope of the present disclosure.

In the configuration of the device of the present disclosure described above, in a configuration in which, in the decomposition reaction of water, using the photocatalyst system of the so-called “Z-scheme”, by disposing the hydrogen-side photocatalyst for eliciting a reaction for generating the hydrogen gas, and the oxygen-side photocatalyst for eliciting a reaction for generating the oxygen gas in separate water tanks, selective recovery of the hydrogen gas is facilitated by separating the water tank for mainly generating the hydrogen gas and the water tank for mainly generating the oxygen gas, a light emitting diode with high monochromaticity is used as a light source for generating the irradiation light to the hydrogen-side and oxygen-side photocatalysts. According to such a configuration, as described above, unlike the case of sunlight, the emission wavelength of the light emitting diode can be selected so as to be as long as possible at a wavelength equal to or less than the wavelength corresponding to the band gap of the photocatalyst to be used, whereby the utilization efficiency of the energy of the irradiation light in the hydrogen gas generation can be easily improved. Further, when the light source is the light emitting diode, it is easy to increase the intensity of the irradiation light at the light wavelength contributing to the decomposition reaction of water, or at the light wavelength selected so as to increase the utilization efficiency of the energy, and thus, it is expected that an increase in the amount of hydrogen gas generated per hour can also be easily carried out. Further, it is also advantageous in that, since the light source is the light emitting diode, the device of the present disclosure can be installed at any place as long as the water tank can be disposed, and the limitation of the disposing location can be reduced, and the amount of hydrogen gas generated is less likely to be influenced by the weather conditions.

In the configuration of the device of the present disclosure described above, it is desirable that the hydrogen-side photocatalyst and the oxygen-side photocatalyst are configured to be directly irradiated with an irradiation light from the hydrogen-side light irradiation unit and an irradiation light of the oxygen-side light irradiation unit, respectively, so that the reaction in each photocatalyst occurs more reliably and highly efficiently. In this regard, the light sources of the hydrogen-side light irradiation unit and the oxygen-side light irradiation unit are the light emitting diodes, and the disposing location can be set relatively easily and can be easily disposed at any place. Therefore, the device of the present disclosure is also advantageous in that designing an optical path from the light source in each of the hydrogen-side light irradiation unit and the oxygen-side light irradiation unit to the hydrogen-side photocatalyst member and the oxygen-side photocatalyst member in order that the irradiation lights each directly hits the hydrogen-side photocatalyst and the oxygen-side photocatalyst, is easy. When the emission wavelength of the light source is equal to or less than the wavelength corresponding to the larger energy width of the band gap of the hydrogen-side photocatalyst and the band gap of the oxygen-side photocatalyst, both photocatalysts can be excited by light from the same light source. Therefore, the light source of the light emitting device of the hydrogen-side light irradiation unit and the light source of the light emitting device of the oxygen-side light irradiation unit may be the same, as long as a condition that the wavelengths thereof are equal to or less than the wavelength corresponding to the larger energy width of the band gap of the hydrogen-side photocatalyst and the band gap of the oxygen-side photocatalyst, is satisfied. In this case, two types of light sources need not be prepared, which is advantageous. In this case, the light source of the hydrogen-side light irradiation unit and the light source of the oxygen-side light irradiation unit may be a common single light source (may be different light sources of the same type).

In the case of the photocatalyst system of the Z-scheme adopted in the device of the present disclosure described above, as described above, the band gap of the hydrogen-side photocatalyst is only required to straddle the reduction potential of the protons and the redox potential of the mediator material, and it is desirable that the band gap of the hydrogen-side photocatalyst is narrower than the energy width between the reduction potential of the protons and the oxidation potential of the water molecules. In such a configuration, since potential of the top of the valence band of the hydrogen-side photocatalyst (the boundary between the band gap and the valence band) is on a negative side than the oxidation potential of the water molecules, an oxidation reaction of the water molecules is substantially not occurred. The gas generated in the hydrogen-side water tank is substantially only hydrogen gas, and therefore, it is possible to recover a highly concentrated hydrogen gas without causing the gas generated in the hydrogen-side water tank to pass through a separator for separating the hydrogen gas and the oxygen gas. Here, the gas recovered from the water tank may be passed through a hydrogen gas separator to remove water vapor and other air components. Even in this case, since the purity of the hydrogen gas in the gas recovered from the water tank is high, the purity in the separation process is further increased, or the requirement for the separation capability is reduced, which is advantageous.

In the case where a band gap of the hydrogen-side photocatalyst is narrower than an energy width between reduction potential of the protons and oxidation potential of the water molecules, an emission wavelength of a light emitting diode of the hydrogen-side light irradiation unit may be equal to or less than a light wavelength corresponding to an energy width of the band gap of the hydrogen-side photocatalyst, and may be longer than a light wavelength corresponding to the energy width between the reduction potential of the protons and the oxidation potential of the water molecules. According to this configuration, since the photon energy in the irradiation light to the hydrogen-side photocatalyst may be lower than the energy width between the reduction potential of the protons and the oxidation potential of the water molecules, it is advantageous in that the type of light emitting diode that can be used is increased. In this regard, as already mentioned, in general, the light emission efficiency per power of the light emitting diode is higher as the emission wavelength is longer. Therefore, the light emitting diode having a longer wavelength can be used, and the light intensity per power is increased and the energy efficiency in the generation of the hydrogen gas in the photocatalyst can be improved.

In the above-described configuration, similarly to the hydrogen-side photocatalyst, the band gap of the oxygen-side photocatalyst is only required to straddle the oxidation potential of the water molecules and the redox potential of the mediator material, and is desired to be narrower than the energy width between the reduction potential of the protons and the oxidation potential of the water molecules. Thus, potential of the bottom of the conduction band of the oxygen-side photocatalyst (the boundary between the conduction band and the band gap) is on a positive side than the reduction potential of the protons, and substantially not generating hydrogen gas in the oxygen-side water tank is possible. Further, the emission wavelength of the light emitting diode of the oxygen-side light irradiation unit may be equal to or less than the light wavelength corresponding to the energy width of the band gap of the oxygen-side photocatalyst, and may be a longer wavelength than the light wavelength corresponding to the energy width between the reduction potential of the protons and the oxidation potential of the water molecules. Therefore, it is possible to increase the type of the available light emitting diode, and to reduce the energy consumed in the generation of the hydrogen gas in the photocatalyst with the light intensity per power being increased.

Further, in the configuration of the present disclosure described above, it is desirable that the potential at the top of the valence band of the hydrogen-side photocatalyst is on the negative side than the oxidation potential of the water molecules, and the potential at the bottom of the conduction band of the oxygen-side photocatalyst is on the positive side than the reduction potential of the protons. According to this configuration, the gas generated by the decomposition reaction of water can be theoretically only the hydrogen gas in the hydrogen-side water tank, and can be only the oxygen gas in the oxygen-side water tank. This is advantageous in that an increase in the yield of the hydrogen gas in the hydrogen-side water tank is expected, and high-purity hydrogen gas can be recovered without using a separator. The gas generated in the hydrogen-side water tank may be passed through the separator to remove impurities other than the hydrogen gas. In this case, the purity of the hydrogen gas of the gas before passing through the separator is expected to be high, and therefore the purity in the separation process is further increased or the requirement for the separation capability is reduced, which is advantageous.

Incidentally, as also shown in JP 2015-218103 A, it has been found that, when the water temperature increases, the decomposition reaction of water is promoted, and the yield of the hydrogen gas increases. Therefore, in the above-described configuration of the present disclosure, a unit for heating the water in each water tank using the exhaust heat (heat emitted along with light emission in the light emitting diode) from the light emitting device of each of the hydrogen-side light irradiation unit and the oxygen-side light irradiation unit may be provided. According to such a configuration, it is expected that the hydrogen gas can be recovered with higher energy efficiency by promoting the decomposition reaction of water without using a unit for heating water separately.

Thus, the device of the present disclosure that produces the hydrogen gas by the decomposition reaction of water by the light irradiation is configured as follows. The photocatalyst system of the Z-scheme is adopted, the light emitting diode is used as the light source of the light irradiated to each of the hydrogen-side photocatalyst and the oxygen-side photocatalyst, and the hydrogen-side photocatalyst and the oxygen-side photocatalyst are disposed in separate water tanks to separate the water tank for mainly generating the hydrogen gas and the water tank for mainly generating the oxygen gas. Therefore, selective recovery of the hydrogen gas is possible more easily, selection of the type of material available as a photocatalyst and the type of light emitting diode available as an irradiation light source becomes easy, the energy utilization efficiency is improved, and the limitation of the disposing location of the device is small and the device can be installed at any place. According to the configuration of the device of the present disclosure, it is expected that the hydrogen gas production device using the decomposition reaction of water by the photocatalyst can be more easily utilized. When a photovoltaic power generation system or a power generation system using other renewable energy is used as the power source of the light emitting diode, it is expected that production of the hydrogen gas can be achieved more efficiently while suppressing emission of carbon dioxide.

Other objects and advantages of the present disclosure will become apparent from the following description of preferred embodiments of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram (cross-sectional view) of one of the hydrogen gas production devices according to the present embodiment;

FIG. 2 is a diagram for explaining a reaction occurring in the photocatalyst in the hydrogen gas production device according to the present embodiment;

FIG. 3 is a diagram for explaining the relation between the potential at the top of the bottom CBM and valence band VBM of the conduction band of the hydrogen-side photocatalyst HEP and the oxygen-side photocatalyst OEP that can be selected in the hydrogen gas production device according to the present embodiment, the reduction potential V_{H}, the oxidation potential V_{O} of the water molecule, and the oxidation-reduction potential V_{M} of the mediator material;

FIG. 4 is a graph illustrating the efficiency of conversion of input electrical energy to light energy in various light emitting diodes. The notation marked with black circles in the figure is the type and effectiveness of LED; and

FIG. 5 is a schematic diagram (cross-sectional view) of a configuration in which a common light source is used for the hydrogen side and the oxygen side in the hydrogen gas production device according to the present embodiment.

### DETAILED DESCRIPTION OF EMBODIMENTS

### Configuration of Hydrogen Gas Production Device

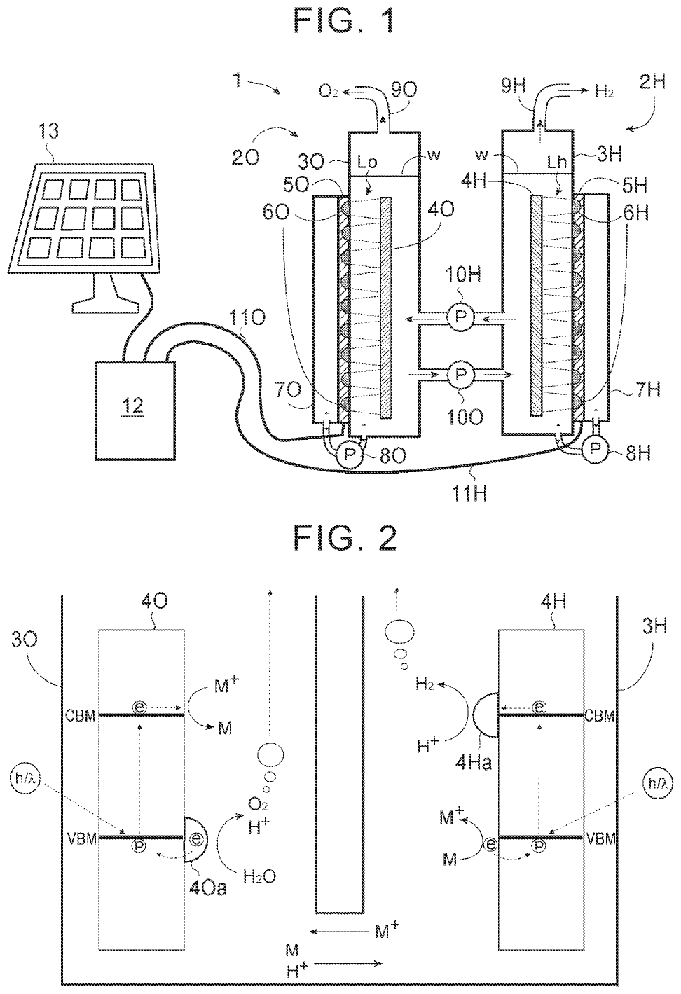

As shown in FIG. 1, the hydrogen gas production device 1 of the present embodiment is constituted by a hydrogen-side device 2H that exclusively or mainly generates hydrogen gas, and an oxygen-side device 2O that exclusively or mainly generates oxygen gas, in one embodiment. The hydrogen-side device 2H and the oxygen-side device 2O each have a hydrogen-side water tank 3H of any form and an oxygen-side water tank 3O, and the hydrogen-side photocatalyst member 4H and the oxygen-side photocatalyst member 4O are disposed in 3H, 3O of the water tank while being immersed in water (liquid) w stored therein. In the water w, as will be described later, a mediator material which is reversibly oxidized or reduced for transferring electrons from the oxygen-side water tank 3O to the hydrogen-side water tank 3H is dispersed or dissolved in the hydrogen gas generation process. Hydrogen-side photocatalyst member 4H and the oxygen-side photocatalyst member 4O, glass, on the surface of the member of any shape made of resin or the like, the hydrogen-side photocatalyst and the oxygen-side photocatalyst described later is formed by being adhered or coated, hydrogen-side photocatalyst, oxygen-side photocatalyst itself may be formed by solidifying into any shape (hydrogen-side photocatalyst member 4H and oxygen-side photocatalyst member 4O is a plate-like member extending in a direction perpendicular to the paper surface, may be any other shape, it may be fixed to the inner wall of the water tank). Then, the hydrogen-side photocatalyst member 4H and the oxygen-side photocatalyst member 4O, respectively, in order to irradiate the light Lh, Lo, the outer or inner of the water tank 3H, 3O, the hydrogen-side light emitting device 5H and the oxygen-side light emitting device 5O that are aligned with a plurality of LED6H, 6O as a light source are arranged. Further, in the water tank 3H, 3O, as will be described later, the mediator material oxidized on the hydrogen-side photocatalyst member 4H is transferred to the oxygen-side photocatalyst member 4O, the mediator material reduced on the oxygen-side photocatalyst member 4O, a mechanism 10H, 10O for circulating the water w in the water tank 3H, 3O for transferring the protons generated in the oxidation reaction of water to the hydrogen-side photocatalyst member 4H is provided. Specifically, such a mechanism may be achieved by, for example, a configuration in which the vicinity of the bottom of the water tank 3H, 3O is communicated with each other by pipes, and the water in one water tank is forcibly delivered to the other water tank through the communication pipe by using the pump P or the like.

In the above configuration, the power for driving LED6H, 6O of the hydrogen-side light emitting device 5H and the oxygen-side light emitting device 5O may be the power obtained in any manner. The electrical power may preferably be provided by solar-derived energy or other renewable energy generated by a solar panel or the like. To this end, the light emitting device 5H, 5O may be configured to receive electric power from the battery 12, which is charged with the amount of electric power generated by the power generation source using renewable energy such as the solar panel 13, through the power transmission line 11H, 11O (the power transmission line 11H, 11O may be directly connected to the power generation source 13 and supplied with electric power to the light emitting device). In this regard, according to the configuration in which the irradiation light to the photocatalyst member 4H, 4O is obtained by LED6H, 6O, the wavelength of the irradiation light can be absorbed by the photocatalyst, and the energy lost by the thermal relaxation after the light absorption is selected so as to be smaller, it is possible to improve the utilization efficiency of the energy of the irradiation light in the decomposition reaction of water, by increasing the light intensity at such a wavelength, it is possible to increase the generation of hydrogen gas per unit time, further, it is possible to obtain benefits such as easy designing of the configuration for arranging LED6H, 6O. In addition, when the irradiation light to the photocatalyst member 4H, 4O is obtained by LED6H, 6O, unlike the case where the irradiation light is the sunlight, there is little restriction on the arrangement location of the hydrogen gas production device 1 (the arrangement location may be a place where the sunlight does not reach), the generation amount of hydrogen gas is not affected by the weather conditions it can also be obtained. The water tank 3H, 3O need not be juxtaposed as shown and may be located anywhere, whether outdoors or indoors, respectively.

The decomposition reaction of water by the photocatalyst is promoted by an increase in water temperature (see JP 2015-218103 A). Therefore, a heat exchanger 7H, 7O that exchanges heat between the water and the light emitting device 5H, 5O may be provided so that the water in the water tank 3H, 3O is heated by the exhaust heat emitted from the hydrogen-side light emitting device 5H and the oxygen-side light emitting device 5O. In the heat exchanger 7H, 7O, the water in the water tank 3H, 3O may be drawn into the vicinity of the hydrogen-side light emitting device 5H and the oxygen-side light emitting device 5O using the pumping 8H, 8O, and the exhaust heat of LED6H, 6O may be conducted to the water. According to this configuration, in order to warm the water in the water tank, there is no need to separately prepare a heat source, and the waste heat of LED6H, 6O contributes to the decomposition reaction of the water, so that the energy-efficiency can be improved.

The gas generated in the hydrogen-side water tank 3H and the gas generated in the oxygen-side water tank 3O are respectively recovered through the product gas recovery pipe 9H, 9O. In the device of the present embodiment, basically, the gas generated in the hydrogen-side water tank 3H is hydrogen gas H₂ , and therefore, if the purity of the hydrogen gas H₂ in the gas recovered in the recovery pipe 9H is sufficiently high, a separator for separating the hydrogen gas is not required. However, since the impurities may include water vapor, oxygen gas, or other gas, any separation process for increasing the purity of the hydrogen gas may be performed.

### Production Reaction Process of Hydrogen Gas in the Present Embodiment

In the hydrogen gas production device of the present embodiment, as described above, in a configuration in which a hydrogen gas is generated by causing a decomposition reaction of water using a photocatalyst system of a so-called “Z scheme”, a water tank that causes a reduction reaction of protons and a water tank that causes an oxidation reaction of water are separately configured.

Specifically, as shown in FIG. 2, in the present embodiment, first, the hydrogen-side photocatalyst member 4H is disposed in the hydrogen-side water tank 3H, and the oxygen-side photocatalyst member 4O is disposed in the oxygen-side water tank 3O.

In addition, a mediator material (M/M⁺) for transporting electrons from the oxygen-side photocatalyst member 4O to the hydrogen-side photocatalyst member 4H is dispersed or dissolved in water. As the mediator substance, a redox substance which reversibly accepts or releases electrons and becomes a redox or an oxidic substance is used, as described later.

In the generated reaction, first, on the hydrogen-side photocatalyst 4H, when the photon h/λ is absorbed, the electron e of the valence band VBM is excited to the conduction band CBM, the potential of the bottom CBM of the conduction band is negative side than the reduction potential of the proton, according to the half-reaction equation below, the electron of the conduction band is donated to the proton H⁺, hydrogen molecule H₂ (hydrogen gas) is generated.

2H⁺+2e⁻H₂ (1)

Further, since the potential of the top VBM of the valence band of the hydrogen-side photocatalyst 4H is more positive than the redox potential of the mediator material M, electrons e are donated from the reduced mediator material M to the hole p generated in the valence band VBM, the oxidant M⁺ of the mediator material M is generated. Then, the oxidant M⁺ of the mediator material is transported to the oxygen-side water tank 3O by the water circulation mechanism 10H as described above.

On the other hand, on the oxygen-side photocatalyst 4O, when the photon h/λ is absorbed, the electron e of the valence band VBM is excited to the conduction band CBM to generate a hole p in the valence band VBM, since the potential of the top VBM of the valence band is more positive than the oxidation potential of water, according to the half-reaction equation below, the water molecule H₂ O donates an electron e to the hole p, the oxygen molecule O₂ and the proton H⁺ is generated.

2H₂O→O₂+4H⁺+4e⁻ (2)

Further, since the potential on the bottom CBM of the conduction band of the oxygen-side photocatalyst 4O is more negative than the redox potential of the mediator material M, the electron e excited in the conduction band CBM is donated to the oxidant of the mediator material M, and the reductant M of the mediator material M is generated. The reductant M of the mediator material and the proton H⁺ are transported to the hydrogen-side water tank 3H by the water circulation mechanism 10O as described above.

Typically, in the hydrogen-side photocatalyst 4H, a co-catalyst 4Ha is added to the hydrogen-side photocatalyst 4H so that the reduction reaction of protons occurs preferentially over the reduction reaction of the oxidant M⁺ of the mediator material (and the oxidation reaction of water molecules). The presence of the co-catalyst 4Ha substantially promotes only the donation of electrons to the protons, which substantially results in little reduction of the oxidant M⁺ of the mediator material (also, since there is no co-catalyst on the hydrogen-side photocatalyst 4H to promote the oxidation reaction of the water molecules, the oxidation reaction of the water molecules will hardly occur). Similarly, in the oxygen-side photocatalyst 4O, a co-catalyst 4Oa is added to the oxygen-side photocatalyst 4O such that the oxidation reaction of the water molecule occurs preferentially over the oxidation reaction of the reductant M of the mediator material (and the reduction reaction of protons).

The presence of the co-catalyst 4Oa substantially promotes only the donation of electrons from the water molecule to the hole p, and substantially hardly causes oxidation of the reductant M of the mediator material (since there is no co-catalyst on the oxygen-side photocatalyst 4O to promote the reduction reaction of the protons, the reduction reaction of the protons will hardly occur).

With the above configuration, in the hydrogen-side water tank 3H, hydrogen gas is generated exclusively or mainly, and in the oxygen-side water tank 3O, oxygen gas is generated exclusively or mainly.

### Types of Photocatalysts Usable in the Present Embodiment

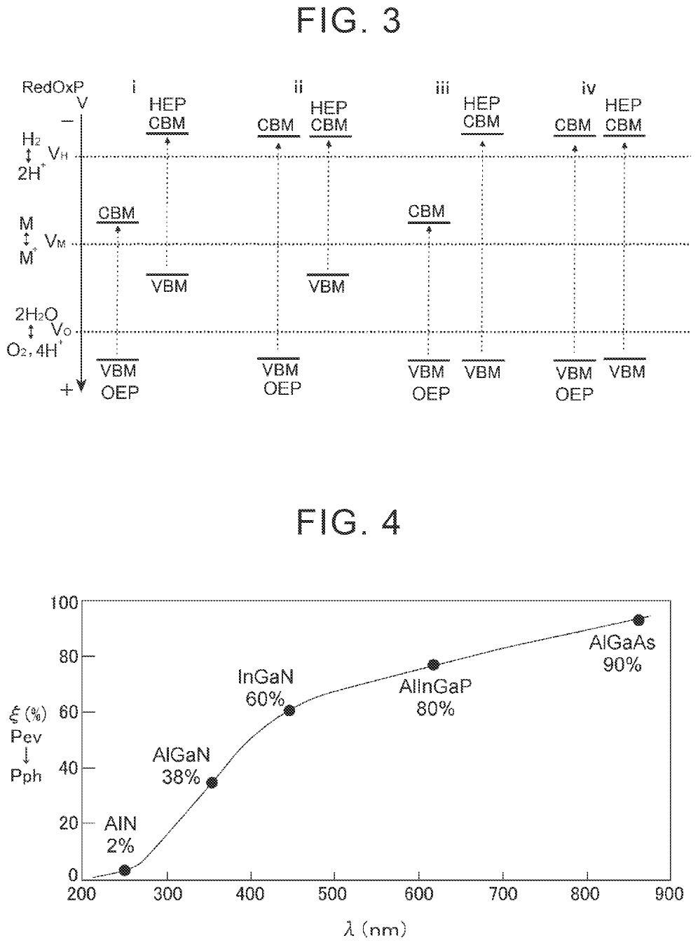

Referring to FIG. 3, as described above, in the photocatalyst employed in the present embodiment, in the hydrogen-side HEP, the band gap (CBM-VBM) crosses the reduction potential V_{H}of the proton and the redox potential V_{M} of the mediator material M, and in the oxygen-side OEP, the band gap (CBM-VBM) crosses the redox potential V_{M} of the mediator material M and the oxidation potential V_{O} of the water are selected. In this regard, as shown in (i) of FIG. 3, it is preferable that, in the hydrogen-side HEP, a catalyst whose potential VBM at the top of the valence band is more negative than the oxidation potential V_{O} of water is selected, and in the oxygen-side OEP, a catalyst whose potential

CBM at the bottom of the conduction band is more positive than the reduction potential V_{H} of the proton is selected so as to reliably prevent oxidation of water molecules at the hydrogen-side and reduction of protons at the oxygen-side. However, as described above, since the co-catalyst is appropriately used, the oxidation of the water molecule is not induced on the hydrogen side and the reduction of the proton is not induced on the oxygen side, as shown in (ii) to (iv) in FIG. 3, in at least one of the hydrogen side HEP and the oxygen side OEP, a material in which the band gap (CBM-VBM) straddles the reduction potential V_{H} of the proton and the oxidation potential V_{O} of the water may be used.

However, from the viewpoint of selecting LED as the illumination light source, it is preferable that the band gap of the photocatalyst is as narrow as possible in both the hydrogen-side HEP and the oxygen-side OEP. More specifically, first, the narrower the bandgap of the photocatalyst, the longer the light wavelength required for excitation of electrons in the photocatalyst. On the other hand, as shown in FIG. 4, generally, if a LED having a longer emission wavelength λ can be used, a higher light intensity can be obtained with a smaller energy, and the hydrogen-gas generation quantity can be increased because efficiency ξ(%) of the emission intensity Pph with respect to the power Pev in the LED becomes higher as the emission wavelength λ becomes longer. Therefore, as described above, by selecting a photocatalyst as narrow as possible in the band gap and adopting a LED having a long emission wavelength λ correspondingly, it is possible to improve the energy-efficiency in the generation of hydrogen-gas. Specifically, in the hydrogen-side or oxygen-side photocatalyst, when a photocatalyst having a band gap smaller than the energy width between the reduction potential of the proton and the oxidation potential of the water molecule is selected, it is preferable that the emission wavelength is shorter than the light wavelength corresponding to the energy width of the band gap of the photocatalyst, and a

LED longer than the light wavelength corresponding to the energy width between the reduction potential of the proton and the oxidation potential of the water molecule is selected as LED of the hydrogen-side or oxygen-side.

As the photocatalyst and the co-catalyst in the present embodiment, for example, the following catalysts can be used. Hydrogen-side photocatalyst: Rh doped SrTiO₃,CdSe,Ta₃N₅,La₃Ti₂CuS₅O₇,Y₂Ti₂O₅S₂,Si,CuO,Cu₂O,ZnMn₂O₄,CuBi₂O₄,CuNb₃O₈ , CuFeO₂,MnV₂O₅,CuInS₂,AgIn₅S₈,Ir—La doped BaTa₂O₆ ,Ir—La doped SrTiO₃,CuGaS₂,CuGaZn₂S₄
Hydrogen-side co-catalyst: Pd,Rh,Ru,Ni,Au,Fe,NiO,RuO2,Cr—Rh oxide
Oxygen-side photocatalyst; BiVO₄,WO₃,CuWO₄,ZnFe₂O₄,BiOI,Bi₂MoO₆ ,Rh—Sb doped TiO₂,Rh—Ba doped NaNbO₃,Ir doped SrTiO₃
Oxygen-generating co-catalyst: IrO₂, Co,Fe,C,Ag,CoO,Co₃O₄

### Types of Mediator Materials Available in This Embodiment

As the mediator substance, for example, the following substances can be used.: [Co(bpy)₃]^{3+/2+},FeSO₄,K₄[Fe(CN)₆]·3H₂O,Fe(NO₃)₃5H₂O,K₃[Fe(CN)₆]

### Modification of the Hydrogen Gas Production Device

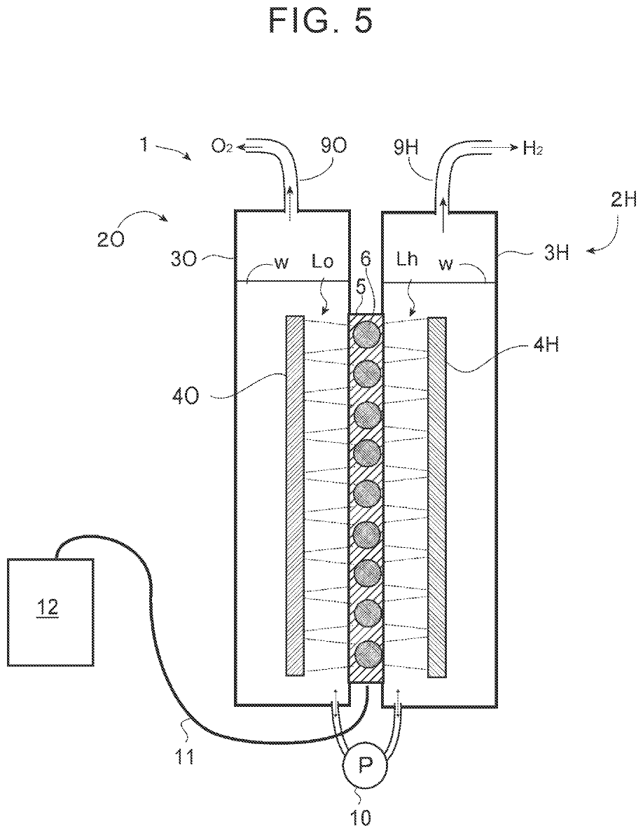

In the device of the present embodiment, with respect to the irradiation light to the hydrogen-side photocatalyst member 4H and the oxygen-side photocatalyst member 4O, if the wavelength is equal to or smaller than the wavelength corresponding to the larger energy width of the band gap of the hydrogen-side photocatalyst and the band gap of the oxygen-side photocatalyst, the light of a single wavelength, both photocatalysts can be excited. Therefore, in the apparatus of the present embodiment, the light emitting device that irradiates the hydrogen-side photocatalyst member 4H and the oxygen-side photocatalyst member 4O with light may be the same. Specifically, as shown in FIG. 5, for example, the light emitting device 5 carrying a LED6 may be disposed between the hydrogen-side water tank 3H and the oxygen-side water tank 3O, and LED6 may be used as a shared light source of the illumination light Lh, Lo. At this time, the wall surface of the water tank may be contacted with the light emitting device 5 by, for example, sandwiching the light emitting device 5 between the water tank 3H and the water tank 3O so that the waste heat when LED6 is driven by electric power can warm the water in the water tank.

Thus, in the present embodiment, a device for producing hydrogen gas by a decomposition reaction of water using a photocatalyst, employing a photocatalyst system of the Z scheme, the water tank is separated into a water tank for generating hydrogen gas and a water tank for generating oxygen gas, in a configuration capable of recovering the hydrogen gas in high purity without passing the generated gas through the separator, a configuration using a LED as a light source of the illumination light for exciting the photocatalyst is provided. By using a monochromatic LED driven by electric power as the irradiation light source, the ratio of the energy contributing to the hydrogen gas generation in the irradiation light can be increased, the generation amount and the efficiency of the hydrogen gas can be improved, the degree of freedom in the arrangement location of the device can be increased, and the generation of the hydrogen gas can be made less susceptible to the weather conditions.

While the foregoing description has been made in connection with embodiments of the disclosure, it will be apparent to those skilled in the art that many modifications and variations are readily possible, and that the disclosure is not limited to the embodiments illustrated above, but may be applied to various devices without departing from the spirit of the disclosure.

What is claimed is:

1. A hydrogen gas production device comprising:
a hydrogen gas generation unit;
an oxygen gas generation unit; and
a water circulation unit, wherein:
the hydrogen gas generation unit
includes a hydrogen-side water tank in which a hydrogen-side photocatalyst member supporting a hydrogen-side photocatalyst is immersed in water in which a mediator material is dispersed,
includes a hydrogen-side light irradiation unit that irradiates the hydrogen-side photocatalyst member with light of a wavelength that is absorbed by the hydrogen-side photocatalyst to excite electrons of a valence band of the hydrogen-side photocatalyst to a conduction band,
includes a hydrogen gas recovery unit that recovers hydrogen gas generated in the hydrogen-side water tank, and
is configured such that, when the hydrogen-side photocatalyst is irradiated with the light from the hydrogen-side light irradiation unit, protons in the water are reduced in the hydrogen-side water tank to generate the hydrogen gas, and the mediator material that is reduced is oxidized;
the oxygen gas generation unit
includes an oxygen-side water tank in which an oxygen-side photocatalyst member supporting an oxygen-side photocatalyst is immersed in water in which the mediator material is dispersed,
includes an oxygen-side light irradiation unit that irradiates the oxygen-side photocatalyst member with light of a wavelength that is absorbed by the oxygen-side photocatalyst and to excite electrons of a valence band of the oxygen-side photocatalyst to a conduction band, and
is configured such that, when the oxygen-side photocatalyst is irradiated with the light from the oxygen-side light irradiation unit, water molecules in the water are oxidized in the oxygen-side water tank to generate oxygen gas, and the mediator material that is oxidized is reduced;
the water circulation unit is configured to circulate the water in which the mediator material is dispersed, between the hydrogen-side water tank and the oxygen-side water tank; and
a light source of a light emitting device of the hydrogen-side light irradiation unit and a light source of a light emitting device of the oxygen-side light irradiation unit are light emitting diodes.

2. The hydrogen gas production device according to claim 1, wherein the hydrogen-side photocatalyst and the oxygen-side photocatalyst are configured to be directly irradiated with an irradiation light from the hydrogen-side light irradiation unit and an irradiation light of the oxygen-side light irradiation unit, respectively.

3. The hydrogen gas production device according to claim 2, wherein the light source of the light emitting device of the hydrogen-side light irradiation unit and the light source of the light emitting device of the oxygen-side light irradiation unit are the same.

4. The hydrogen gas production device according to claim 1, wherein a band gap of the hydrogen-side photocatalyst is narrower than an energy width between reduction potential of the protons and oxidation potential of the water molecules, and an emission wavelength of a light emitting diode of the hydrogen-side light irradiation unit is equal to or less than a light wavelength corresponding to an energy width of the band gap of the hydrogen-side photocatalyst, and is longer than a light wavelength corresponding to the energy width between the reduction potential of the protons and the oxidation potential of the water molecules.

5. The hydrogen gas production device according to claim 1, wherein potential at a boundary between the valence band and a band gap of the hydrogen-side photocatalyst is on a negative side of oxidation potential of the water molecules, and potential at a boundary between the conduction band and a band gap of the oxygen-side photocatalyst is on a positive side of reduction potential of the protons.
